(19) United States
(12) Patent Application Publication
(10) Pub. No.: US 2007/0133676 A1
(43) Pub. Date: Jun. 14, 2007

(54) Method and apparatus for encoding and decoding video signal depending on characteristics of coefficients included in block of FGS layer

(75) Inventors: Bae-keun Lee, Bucheon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/590,833

(22) Filed: Nov. 1, 2006

Related U.S. Application Data
(60) Provisional application No. 60/749,062, filed on Dec. 12, 2005.

(30) Foreign Application Priority Data
Mar. 31, 2006 (KR) 10-2006-0029655

(51) Int. Cl. H04B 1/66; H04N 7/12

(52) U.S. Cl. 375/240.1; 375/240.26

(57) ABSTRACT

Encoding and decoding video signals according to the characteristics of coefficients included in the block of a fine granularity scalability layer is provided. Non-unitary coefficients that constitute the block and have absolute values that are not 0 or 1 are extracted from the video signal, a representative value from run values of the extracted non-unitary coefficients is calculated, the run values of the coefficients constituting the block and the representative value are compared, and codewords are assigned to the coefficients according to a result of the comparison.

### CROSS-REFERENCE TO RELATED APPLICATION

This application claims priority from Korean Patent Application No. 10-2006-0029655 filed on Mar. 31, 2006 in the Korean Intellectual Property Office, and U.S. Provisional Patent Application No. 60/749,062 filed on Dec. 12, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate to encoding and decoding of video signals and, more particularly, to encoding and decoding video signals according to the characteristics of coefficients included in the block of a fine granularity scalability layer.

2. Description of the Related Art

As information and communication technology, including the Internet, develop, image-based communication as well as text-based communication and voice-based communication are increasing. The existing text-based communication is insufficient to satisfy consumers' various demands. Therefore, the provision of multimedia services capable of accommodating various types of information, such as text, images and music, is increasing. Since the size of multimedia data is large, multimedia data require high-capacity storage media and broad bandwidth at the time of transmission. Therefore, in order to transmit multimedia data, including text, images and audio, it is essential to use a compression encoding scheme.

The fundamental principle of data compression is to eliminate redundancy from data. Data can be compressed by eliminating spatial redundancy such as the case where an identical color or object is repeated in an image, temporal redundancy, such as a case where there is little change between neighboring frames or an identical audio sound is repeated, or psychovisual redundancy, in which the fact that humans' visual and perceptual abilities are insensitive to high frequencies is taken into account. In a general coding method, temporal redundancy is eliminated using temporal filtering based on motion compensation, and spatial redundancy is eliminated using spatial transform.

Redundancy-free data is subjected to lossy coding based on a predetermined quantization step through a quantization process. Quantized data are losslessly coded through entropy coding.

Recently, as disclosed in the draft of Scalable Video Coding (hereinafter referred to as “SVC”), being prepared by Joint Video Team (JVT) (the video experts group of ISO/IEC (International standards organization/International Electrotechnical Commission)) and International Telecommunication Union (ITU), research into a multi-layer-based coding technique based on existing H.264 has been actively carried out, as shown in the example of FIG. 1.

Entropy coding techniques used in the H.264 standard include Context-Adaptive Variable Length Coding (CAVLC), Context-Adaptive Binary Arithmetic Coding (CABAC), and Exponential Golomb (Exp_Golomb).

Table 1 lists entropy coding schemes used for parameters to be coded in the H.264 standard.

TABLE 1

| | Entropy coding | Entropy coding |
|---|---|---|
| Parameters to be coded | mode = 0 | mode = 1 |
| Macroblock Type | Exp_Golomb | CABAC |
| Macroblock Pattern | | |
| Quantization Parameter | | |
| Reference Frame Index | | |
| Motion Vector | | |
| Residual Data | CAVLC | |

According to Table 1, when an entropy coding mode flag is 0, a macroblock type, indicating whether a corresponding macroblock is an inter prediction mode block or an intra prediction mode block, a macroblock pattern, indicating the type of a subblock constituting part of a macroblock, a quantization parameter, that is, an index to determine a quantization step, a reference frame index, indicating the number of frames that are taken into account in an inter prediction mode, and a motion vector are coded using Exp_Golomb. Furthermore, residual data indicating the difference between the original image and the predicted image is coded using CAVLC.

In contrast, when the entropy coding mode flag is 1, all of the parameters are coded using CABAC.

CABAC exhibits excellent performance for parameters having high complexity. Therefore, Variable Length Coding (VLC)-based entropy coding, such as CAVLC, is set for a basic profile.

FIG. 1 is a diagram illustrating Fine Granularity Scalability (FGS) coding passes.

In JSVM 3.0, a Fine Granularity Scalability (FGS) layer has two types of coding passes, including a significant pass and a refinement pass. The significant pass calculates the block of an FGS layer from the block of a base layer having a value of 0. The refinement pass calculates the block of an FGS layer from the block of a base layer not having a value of 0. In each scan, a transform factor is transmitted. In general, the FGS layer is mostly composed of significant passes. In view of the characteristics of VLC coding, when the significant passes are coded, encoding efficiency can be increased.

Therefore, to increase encoding efficiency, a method and apparatus for applying VLC to an FGS layer are required.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for encoding and decoding video signals which maintain coding efficiency even if the length of a run is great at the time of applying VLC to coefficients included in an FGS layer.

The present invention also provides a method and apparatus to code symbols while taking into account the characteristics of non-unitary coefficients.

According to an aspect of the present invention, there is provided a method of losslessly coding coefficients included in a block of an FGS layer constituting a video signal having a multi-layer structure, the method including extracting non-unitary coefficients that constitute the block and have absolute values that are not 0 or 1; calculating a representative value from run values of the extracted non-unitary coefficients; comparing the run values of the coefficients constituting the block and the representative value; and assigning codewords to the coefficients according to a result of the comparison.

According to another aspect of the present invention, there is provided a method of losslessly coding coefficients included in a block of an FGS layer constituting a coded video signal having a multi-layer structure, the method including extracting a representative value that is added to the coded video signal; extracting codewords from the coded video signal; and, for the representative value, and codewords belonging to first and second groups that are spaced apart from each other at a predetermined distance, transforming and decoding the codeword belonging to the first group and the codeword belonging to the second group using different methods.

According to another aspect of the present invention, there is provided an encoder for losslessly coding coefficients included in a block of an FGS layer constituting a video signal of a multi-layer structure, the encoder including a non-unitary coefficient calculation unit which extracts non-unitary coefficients that constitute a block and have absolute values that are not 0 or 1; a representative value generating unit which calculates a representative value from run values of the extracted non-unitary coefficients; and a coefficient encoding unit which compares each of the run values of the coefficients constituting the block and the representative value, and assigns codewords to the coefficients according to a result of the comparison.

According to another aspect of the present invention, there is provided a decoder for losslessly coding coefficients included in a block of an FGS layer constituting a coded video signal of a multi-layer structure, the decoder including a representative value extraction unit extracting a representative value added to the coded video signal; and a coefficient decoding unit which extracts codewords from the coded video signal, and, for the representative value and codewords belonging to first and second groups that are spaced apart from each other at a predetermined distance, transforms and decodes the codeword belonging to the first group and the codeword belonging to the second group using different methods.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a diagram illustrating FGS coding passes;

FIG. 2 is a block diagram illustrating a VLC encoding process in a 4×4 transform;

FIG. 3 is a flowchart illustrating an encoding process according to an exemplary embodiment of the present invention;

FIG. 4 is a diagram illustrating pseudo code for coding a symbol according to examples of a representative value and a reference value according to an exemplary embodiment of the present invention;

FIG. 5 is a diagram illustrating pseudo code for decoding a symbol when a representative value is coded, according to an exemplary embodiment of the present invention;

FIG. 6 is a diagram illustrating a decoding sequence according to an exemplary embodiment of the present invention;

FIG. 7 is a block diagram illustrating the construction of the entropy coding unit of an encoder according to an exemplary embodiment of the present invention; and

FIG. 8 is a block diagram illustrating the construction of the entropy decoding unit of a decoder according to an exemplary embodiment of the present invention.

### DESCRIPTION OF EXEMPLARY EMBODIMENTS OF THE INVENTION

Merits and characteristics of the invention, and methods for accomplishing them will become more apparent from the following exemplary embodiments taken in conjunction with the accompanying drawings. However, the present invention is not limited to the disclosed exemplary embodiments, but may be implemented in various manners. The exemplary embodiments are provided to complete the disclosure of the present invention and to allow those having ordinary skill in the art to understand the scope of the present invention. The present invention is defined by the category of the claims. The same reference numbers will be used throughout the drawings to refer to the same or like parts.

The present invention will now be described in detail in connection with specific exemplary embodiments with reference to the accompanying drawings regarding block diagrams and flowcharts illustrating a method and apparatus for encoding and decoding video signals according to the characteristics of a coefficient included in the block of an FGS layer. It is to be understood that each block of the processing flowchart drawings and a combination of the flowchart drawings can be executed by computer program instructions. The computer program instructions can be loaded into the processing unit of a general-purpose computer, a special purpose computer, and other programmable data processing equipment. Therefore, the instructions executed by the processing units of the computers or other programmable data processing equipment create means for performing functions described in flowchart block(s). The computer program instructions can be stored in a computer-available or computer readable memory that can be provided to the computer or other programmable data processing equipment in order to implement the functions in a specific manner. Therefore, the instructions stored in the computer-available or computer readable memory can produce manufacturing articles including the instruction means for performing the functions described in the flowchart block(s). Since the computer program instructions can be mounted on the computer or other programmable data processing equipment, a series of operating steps is performed on the computer or other programmable data processing equipment to create a process executed by the computer. Accordingly, the instructions that execute the computer or other programmable data processing equipment can be provided as steps of executing the functions described in the flowchart block(s).

The term “CAVLC” refers to VLC using information about neighboring blocks that have recently been coded. VLC is performed using a coding reference table, which is selected from a plurality of coding reference tables according to information about the blocks neighboring the block that is currently being coded. VLC is a method used to encode residuals (that is, transform coefficient blocks having a zigzag sequence) in video coding. CAVLC has been designed to use several characteristics of quantized blocks.

Blocks that have undergone prediction, transform and quantization have mostly “0”. CAVLC uses run-level coding in order to represent a series of “0s” in a compression manner. After a zigzag scan, the highest non-zero transform coefficients mostly have the values of a series of ±1s. CAVLC converts the number of high-frequency ±1 transform coefficients into a signal in a compression manner. Non-zero transform coefficients of neighboring blocks are correlated. The number of transform coefficients is encoded using a look-up table. The look-up table is selected depending on the number of non-zero transform coefficients of neighboring blocks. There is a tendency for the level (size) of a non-zero transform coefficient to be high at the first of a rearranged arrangement and to be low at high frequencies. CAVLC uses this tendency by adaptively selecting a VLC look-up table for a level parameter depending on a recently coded level.

The CAVLC encoding of the transform coefficients of one block is performed as described below.

The number of non-zero transform coefficients of one block and the number of high frequency ±1 transform coefficients of the block are encoded, and the symbols of the high frequency ±1 transform coefficients of the block are encoded. Thereafter, the levels of the remaining non-zero transform coefficients are encoded. The total number of 0s existing before the last transform coefficient is encoded, and the run of the 0s is encoded.

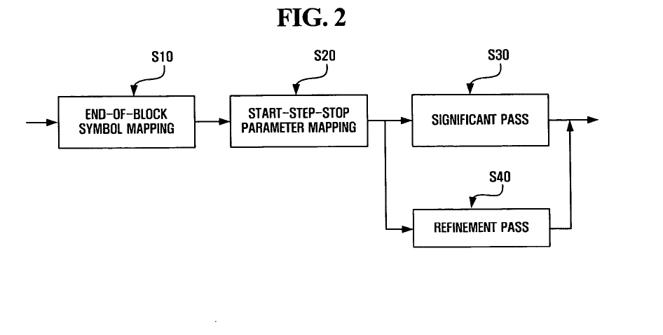

FIG. 2 is a block diagram illustrating a VLC encoding process in a 4×4 transform. In the CAVLC process, End-of-Block (EOB) symbol mapping and start-step-stop mapping are initially performed, thus generating two initialization vectors. A significant pass and a refinement pass are performed based on the two initialization vectors. In the significant pass, the run of respective significant coefficients is coded. In the refinement pass, one VLC table is used. In this case, a VLC table efficiently uses the statistical fact that the refinement bits are mostly 0.

Respective steps will be described below. At the EOB symbol mapping step, a symbol representing the EOB for each scan index is specified. At the start-step-stop parameter mapping step, coding is specified by a parameter called “m”. In the case where significance data is coded, the value of m is determined by a scan index and the recent non-zero index value of a base layer coefficient. The parameter is also coded through run-level coding.

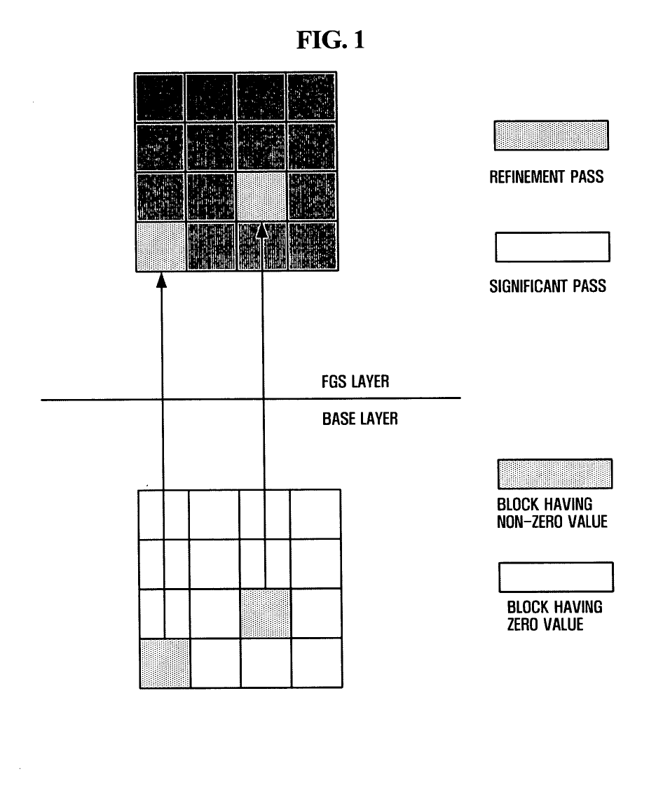

In the significant pass, whether a significant coefficient exists within a block is determined as described with reference to FIG. 1. If it is determined that no significant coefficient exists within the block, an EOB marker is transmitted. If it is determined that a significant coefficient exists within the block, the coding of the block is performed.

In the refinement pass, all of the blocks are encoded at one time as described with reference to FIG. 1. The refinement bits are accumulated in groups and codewords are transmitted according to Table 2.

TABLE 2

| Symbol | Codeword |
|---|---|
| 0000 | 00 |
| 0001 | 010 |
| 0010 | 011 |
| 0011 | 11000 |
| 0100 | 100 |
| 0101 | 11001 |
| 0110 | 11010 |
| 0111 | 111100 |
| 1000 | 101 |
| 1001 | 11011 |
| 1010 | 11100 |
| 1011 | 111101 |
| 1100 | 11101 |
| 1101 | 111110 |
| 1110 | 1111110 |
| 1111 | 1111111 |

meanwhile, in the significant pass, coefficients having values greater than 1 (hereinafter referred to as “non-unitary magnitude coefficients”) are a factor degrading efficiency at the time of coding the significant pass. The reason for this is because, although the non-unitary coefficient occupies about 1.3% to 4.6%, the length of a symbol is great when the non-unitary coefficient is included, thus resulting in reduced coding efficiency. Accordingly, it is necessary to increase coding efficiency by reducing the size of a symbol assigned to the non-unitary coefficient.

A 4×4 block is taken as an example. The run of the non-unitary coefficients approximates 16. In this case, many codewords are generated due to the structure of start-step-stop code. If the frequency of the occurrence of the non-unitary coefficient is increased, bit efficiency is lowered. Accordingly, it is necessary to assign a small codeword by mapping a symbol again.

The construction of the symbol is described below. The symbol is coded in the form of [run, the greatest number, the number of non-unitary coefficients]. However, the symbol may be constructed using other methods. If the length of the run is great, the codeword to be mapped to the symbol can be increased. Consequently, coding efficiency may be degraded.

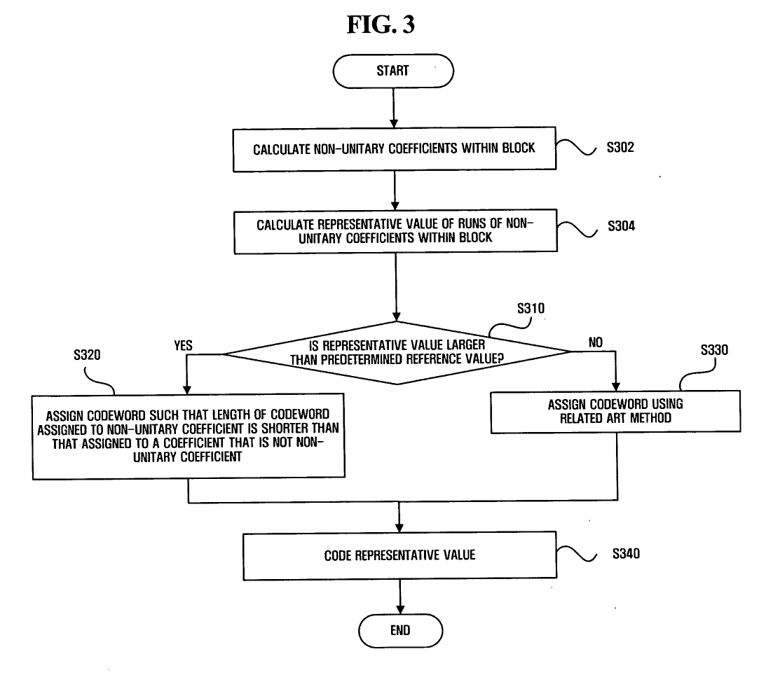

FIG. 3 is a flowchart illustrating an encoding process according to an exemplary embodiment of the present invention. Non-unitary coefficients within a block to be decoded are first calculated at operation S302. The term “non-unitary coefficients” refers to coefficients the absolute values of which are not 0 or 1. The representative value of runs is calculated to represent non-unitary coefficients at operation S304.

The representative value of runs refers to a process of calculating a representative value K representing the characteristic of runs, such as the average value, intermediate value, or highest frequency value of the lengths of runs. If the representative value is high, the size of runs to be coded is great, therefore the coding efficiency may be degraded. One of various reference values may be selected as a criterion for determining the representative value. For example, the approximately intermediate value of the greatest range of runs may be selected. Assuming that the reference value is a threshold (T), the selected representative value K and the reference value T are compared with each other at operation S310. If the selected representative value K is greater than the reference value T, it means that the length of a run is generally great. Therefore, a codeword is assigned such that the length of a codeword assigned to a non-unitary coefficient having a long run length is shorter than that assigned to a coefficient that is not a non-unitary coefficient at operation S320. Meanwhile, if the representative value K is smaller than the reference value T, a codeword is assigned using a related art method at operation S330. The representative value K is then coded at operation S340. If the representative value is not coded, the codeword can be considered to have been coded using the related art method.

Operation S320 is described in more detail below. If a symbol to be decoded is greater than the representative value K, the value that is obtained by subtracting the representative value K from the symbol C is coded (C-K). The reason for this is to code the symbol using a codeword having a smaller size when the length of a run is great. Meanwhile, if a symbol to be decoded is smaller than or equal to the representative value K, a value that is obtained by subtracting the symbol C from a given value is coded. For example, the symbol C may be subtracted from a value 2T (twice the reference value T).

The representative value may be set for blocks, or an entire slice or frame including blocks. The representative value may also be coded together with a video signal. Furthermore, if the representative value has been previously set, information, such as a flag, may be set so as to notify a decoder of the assignment of a codeword through comparison with the representative value.

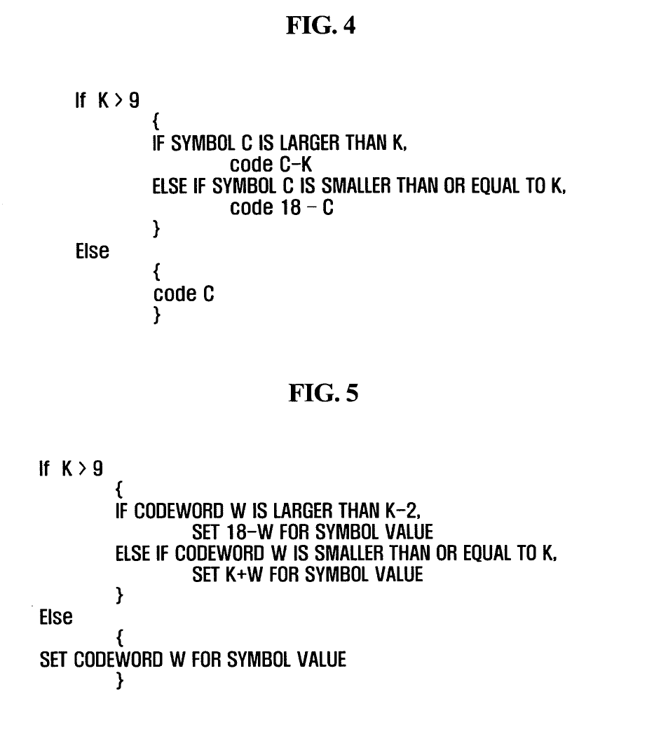

FIG. 4 is a diagram illustrating pseudo code that codes a symbol based on examples of a representative value and a reference value according to an exemplary embodiment of the present invention.

In this case, the reference value T (that is, the reference) can be calculated from a limit value. In the present exemplary embodiment, the limit value is set to 18 and the reference value T is set to 9 (which is half of 18). Since 18 can include a run having a maximum length of 16, 18 is the value that is selected to avoid overlap in new coding. However, this may vary with the coding method.

If the result of K obtained using the representative value, such as the average value or the intermediate value of the length of the run of non-unitary coefficients, is larger than 9 (that is, T), coding may be performed using a method other than the related art method. That is, if the symbol C is larger than K, C-K is coded. If the symbol C is smaller than or equal to K, 18-C is coded.

Meanwhile, if the K value is smaller than 9 (that is, the reference), coding is performed using the related art method. This is because coding efficiency is degraded even if coding is performed using the related art method because the length of the run is not great.

FIG. 5 is a diagram illustrating pseudo code for decoding a symbol when a representative value is coded, according to an exemplary embodiment of the present invention.

A reference value T may be previously set or may be set in one video file itself. Therefore, a description of the transmission of the value T is omitted here.

If, in FIG. 4, the value K has been coded to be a non-zero value, or the value K has been coded and is greater than the value T, it can be determined that a video stream has been coded through the process of operation S320.

Accordingly, cases may be classified into a case where a value is larger than or equal to a value obtained by subtracting the value K from 18, and a case where the value is smaller than the value obtained by subtracting the value K from 18.

For example, if the value K is 10 and the values of symbols are distributed in a range from 11 to 16, values to be coded are 1 to 6. Meanwhile, if the values of the symbols are in a range from 1 to 10, values to be coded are 8 to 17. Coding can be performed according to the pseudo code shown in FIG. 5.

As shown in FIG. 5, the values coded based on the representative value are divided into two groups. For example, it can be seen that two groups exist on the basis of 7, which is obtained by subtracting 3 from the representative value. Therefore, different types of decoding are performed on the two groups.

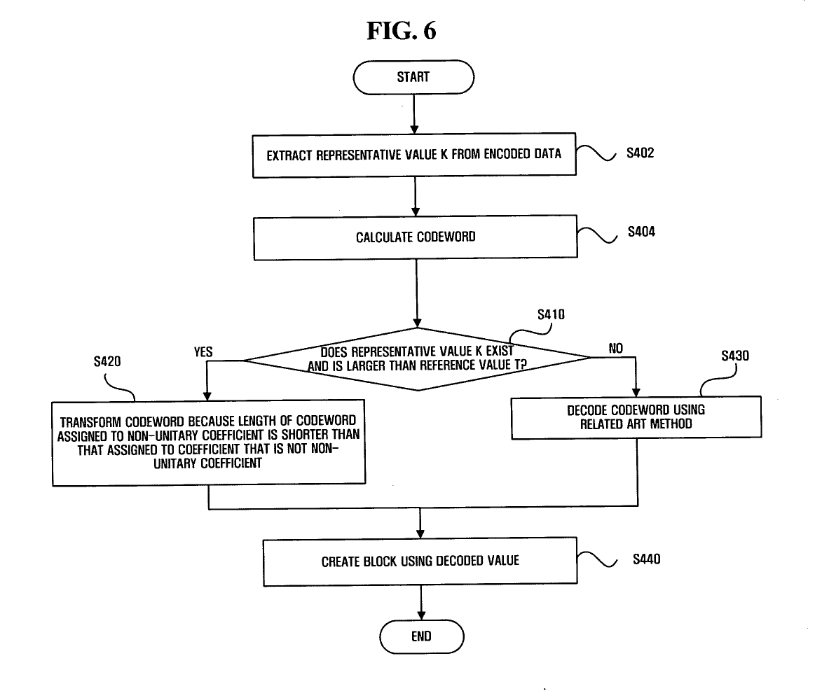

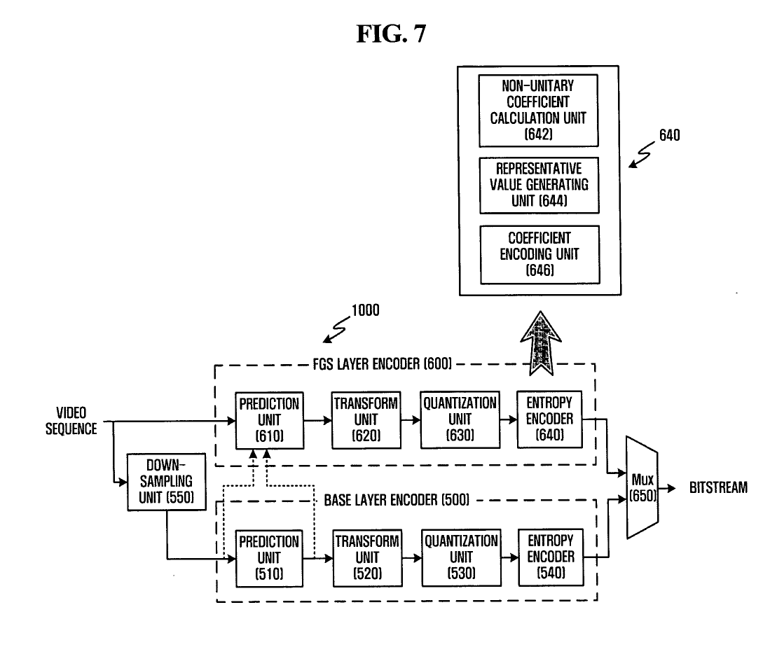

A decoding sequence is described based on the above-described process with reference to FIG. 6.

A representative value K is extracted from encoded video data at operation S402. A codeword, into which a symbol is coded, is then calculated at operation S404. Whether the representative value K exists and is larger than a reference value T is determined at operation S410. If the representative value K exists and is larger than the reference value T, it can be seen that coding has been performed according to operation S320 of FIG. 3, therefore a process of transforming the codeword is performed, as suggested in the pseudo code, at operation S420. If the representative value K does not exist and is smaller than or equal to the reference value T at operation S410, it means that coding has been performed according to operation S330 of FIG. 3. Therefore coding is performed using the related method at operation S430. A block is then created using the decoded value at operation S440.

The representative value K can be obtained by decoding the representative value that is inserted along with the video signal of a slice or frame including the block. Alternatively, if the representative value may be previously set, an encoder may extract information set in a flag so as to determine whether a codeword has been assigned through comparison with the representative value based on the representative value.

The term “unit”, “module” and “table” used in the present exemplary embodiments, refer to software and hardware constituent elements, such as a Field Programmable Gate Array (FPGA) or an Application Specific Integrated Circuit (ASIC). The module performs various functions. However, this does not mean that the module is limited to software or hardware. The module may be configured to exist in a storage medium which is addressable and may be configured to be executed on one or more processing units. For example, the module may include constituent elements, such as software constituent elements, object-oriented software constituent elements, class constituent elements and task constituent elements, processes, functions, attributes, procedures, subroutines, segments of program code, drivers, firmware, microcodes, circuits, data, databases, data structures, tables, arrays, and parameters. Functions provided within the constituent elements and the modules may be combined with a smaller number of constituent elements and modules or may be separated into additional constituent elements and modules. Furthermore, the constituent elements and the modules may be implemented to execute on one or more CPUs within a device.

FIG. 7 is a block diagram illustrating the construction of the entropy coding unit of an encoder according to an exemplary embodiment of the present invention.

An original video sequence is input to an FGS layer encoder 600. The original video sequence may be down-sampled (only when there is variation in resolution between layers) by a down-sampling unit 550, and is input to a base layer encoder 500.

A prediction unit 610 of the FGS layer encoder 600 obtains a residual signal by subtracting an image, which is predicted using a predetermined method, from a current block. The prediction method may include directional intra prediction, inter prediction, intra base prediction, and residual prediction.

A transform unit 620 creates a transform coefficient by transforming the obtained residual signal using a spatial transform method, such as DCT or wavelet transform.

A quantization unit 630 creates a quantization coefficient by quantizing the transform coefficient using a quantization step (the higher the quantization step, the higher the loss and compression ratio of data).

As in the FGS layer encoder 600, the base layer encoder 500 also includes a prediction unit 510, a transform unit 520, and a quantization unit 530, which have the same functions as those of the prediction unit 610, the transform unit 620, and the quantization unit 630, respectively. However, the prediction unit 510 does not use intra base prediction or residual prediction.

An entropy encoder 640 losslessly codes the quantization coefficient and outputs an FGS layer bitstream. In a similar way, an entropy encoder 540 outputs a base layer bitstream. A multiplexer (Mux) 650 creates a bitstream to be transmitted to a video decoder stage by multiplexing the FGS layer bitstream and the base layer bitstream.

The FGS layer entropy encoder 640 is described in detail below. The FGS layer entropy encoder 640 includes a non-unitary coefficient calculation unit 642, a representative value generating unit 644, and a coefficient encoding unit 646.

The non-unitary coefficient calculation unit 642 calculates non-unitary coefficients within a block or frame. Furthermore, the non-unitary coefficient calculation unit 642 can calculate the length of the run of the non-unitary coefficients.

The representative value generating unit 644 generates a value, which can be a representative value, from the calculated length of the run of the non-unitary coefficients. For example, the representative value generating unit 644 can obtain an average value or the highest frequency value. The representative value generating unit 644 can also select an intermediate value from among the lengths of several runs.

The coefficient encoding unit 646 compares the representative value and a predetermined reference value and performs coding presented at operation S320 or operation S330 of FIG. 3. The coefficient encoding unit 646 can also code information about the representative value so that it can be coded in the decoder.

The coefficient encoding unit 646 can set the representative value for a block, or for the entire slice or frame including the block. The representative value can be coded along with a video signal. Furthermore, if the representative value has already been set, information, such as a flag, may be set so as to notify a decoder of the assignment of the codeword through comparison with the representative value.

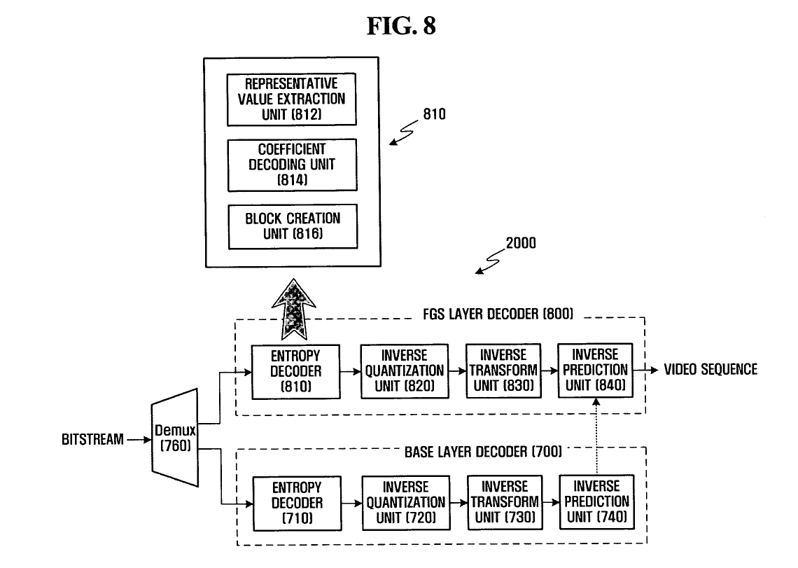

FIG. 8 is a block diagram illustrating the construction of the entropy decoding unit of a decoder according to an exemplary embodiment of the present invention.

An input bitstream is separated into an FGS layer bitstream and a base layer bitstream through a demultiplexer (Demux) 760. The FGS layer bitstream and the base layer bitstream are provided to an FGS layer decoder 800 and a base layer decoder 700, respectively.

An entropy decoder 810 restores a quantization coefficient by performing lossless coding in a manner corresponding to the entropy encoder 640. The entropy decoder 810 includes a representative value extraction unit 812, a coefficient decoding unit 814, and a block creation unit 816. The representative value extraction unit 812 extracts a representative value, which is required to calculate non-unitary coefficients at the time of decoding, from the bitstream. The representative value extraction unit 812 can obtain the representative value by decoding the representative value, which is inserted along with the video signal of the slice or frame including the block. Alternatively, if the representative value has been previously set, the representative value extraction unit can extract information set in a flag so as to determine whether the encoder has assigned a codeword through comparison with the representative value based on the representative value.

The coefficient decoding unit 814 compares the extracted representative value with a predetermined reference value, and performs decoding according to operation S420 or operation S430 shown in FIG. 6. This process has been described above with reference to FIG. 5.

The block creation unit 816 creates a block based on the value decoded in the coefficient decoding unit. The block refers to the FGS block.

An inverse quantization unit 820 performs inverse quantization on information about the restored symbol using the quantization step in the quantization unit 630.

An inverse transform unit 830 performs inverse transform on the inverse-quantized result using an inverse spatial transform method, such as inverse DCT transform or inverse wavelet transform.

An inverse prediction unit 840 obtains a predicted image, which has been obtained in the prediction unit 610, in the same manner, and restores a video sequence by adding the obtained predicted image to the inverse transformed result.

As in the FGS layer decoder 800, the base layer decoder 700 also includes an entropy decoder 710, an inverse quantization unit 720, an inverse transform unit 730, and an inverse prediction unit 740, which have the same functions as those of the entropy decoder 810, the inverse quantization unit 820, the inverse transform unit 830, and the inverse prediction unit 840, respectively.

According to an exemplary embodiment of the present invention, in CAVLC encoding in the significant passes of the FGS layer, coding efficiency can be increased even if the length of a run is great due to the occurrence of non-unitary coefficients.

According to an exemplary embodiment of the present invention, variable length coding can be flexibly performed depending on the occurrence of non-unitary coefficients and the length of a run.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of losslessly coding coefficients included in a block of a fine granularity scalability (FGS) layer constituting a video signal having a multi-layer structure, the method comprising:
extracting non-unitary coefficients of the block that have absolute values that are not 0 or 1;
calculating a representative value from run values of the non-unitary coefficients which are extracted;
comparing the run values of the non-unitary coefficients of the block and the representative value; and
assigning codewords to the non-unitary coefficients according to a result of the comparing.

2. The method of claim 1, wherein the calculating the representative value comprises calculating an average value, an intermediate value or a most frequently occurring value of the run values of the non-unitary coefficients constituting the block.

3. The method of claim 1, wherein assigning the codewords comprises assigning the codewords so that a length of a codeword assigned to a non-unitary coefficient is greater than that assigned to a coefficient that is not the non-unitary coefficient.

4. The method of claim 1, further comprising, after the calculating the representative value:
comparing a reference value and the representative value; and
assigning the codewords if the representative value is greater than the reference value.

5. The method of claim 4, wherein the reference value is a value that is calculated from a highest run value of the run values.

6. The method of claim 1, wherein the assigning the codewords comprises:
as a result of the comparing each of the run values of the non-unitary coefficients constituting the block and the representative value,
if the run value is larger than the representative value, coding a symbol including the non-unitary coefficient using a value that is obtained by subtracting the representative value from the run value of the non-unitary coefficient; and
if the run value is smaller than or equal to the representative value, coding the symbol including the non-unitary coefficient using a value that is obtained by subtracting the run value of the non-unitary coefficient from a limit value.

7. The method of claim 6, wherein the limit value is a value that is calculated from a value greater than the highest value of the run values.

8. The method of claim 1, further comprising, after the assigning the codewords, coding information about a reference value.

9. The method of claim 1, further comprising inserting the representative value into a video signal of a slice or frame, including the block, and coding the representative value along with the video signal.

10. The method of claim 1, further comprising setting information providing notification of the assignment of the codewords through comparison with the representative value, wherein the representative value has been previously set.

11. A method of losslessly coding coefficients included in a block of a fine granularity scalability (FGS) layer constituting a coded video signal having a multi-layer structure, the method comprising:
extracting a representative value that is added to the coded video signal;
extracting codewords from the coded video signal; and
for the representative value, and codewords belonging to first and second groups that are spaced apart from each other at a distance, transforming and decoding the codewords belonging to the first group and the codewords belonging to the second group using different methods.

12. The method of claim 11, wherein the extracting the representative value comprises extracting a value that is encoded in the video signal.

13. The method of claim 11, further comprising, after calculating the representative value, comparing a reference value and the representative value.

14. The method of claim 11, wherein the reference value is a value that is calculated from a highest run value of the run values.

15. The method of claim 11, wherein:
the codeword belonging to the first group is smaller than the codeword belonging to the second group;
the different methods include first and second different methods;
the first method is a method of setting a value that is obtained by adding the representative value to a decoded value of the codeword belonging to the first group, for a run value of the coefficients; and
the second method is a method of setting a value that is obtained by subtracting a decoded value of the codeword belonging to the second group from a limit value, for the run value of the coefficients.

16. The method of claim 15, wherein the limit value is a value that is calculated from a value greater than a highest run value of the run value.

17. The method of claim 11, further comprising, after the decoding, creating a block using a decoded coefficient.

18. The method of claim 11, wherein the extracting the representative value added to the coded video signal comprises decoding the representative value that is inserted along with a video signal of a slice or frame including the block.

19. The method of claim 11, further comprising setting information providing notification of assignment of the codeword through comparison with the representative value, wherein the representative value has been previously set.

20. An encoder for losslessly coding coefficients included in a block of a fine granularity scalability (FGS) layer constituting a video signal of a multi-layer structure, the encoder comprising:
a non-unitary coefficient calculation unit which extracts non-unitary coefficients of a block and have absolute values that are not 0 or 1;
a representative value generating unit which calculates a representative value from run values of the non-unitary coefficients which are extracted; and
a coefficient encoding unit which compares each of the run values of the non-unitary coefficients constituting the block and the representative value, and assigns codewords to the non-unitary coefficients according to a result of the comparison.

21. The encoder of claim 20, wherein the representative value generating unit calculates an average value, an intermediate value or a most frequently occurring value of the run values of the non-unitary coefficients of the block.

22. The encoder of claim 20, wherein the coefficient encoding unit assigns the codewords so that a length of a codeword assigned to a non-unitary coefficient is greater than that assigned to a coefficient that is not the non-unitary coefficient.

23. The encoder of claim 20, wherein the coefficient encoding unit compares a reference value and the representative value, and assigns the codewords if the representative value is greater than the reference value.

24. The encoder of claim 23, wherein the reference value is a value that is calculated from a highest run value of the run values.

25. The encoder of claim 20, wherein the coefficient encoding unit:
codes a symbol including the non-unitary coefficients using a value that is obtained by subtracting the representative value from the run value of the non-unitary coefficients if, as a result of comparing each of the run values of the coefficients of the block and the representative value, the run value is found to be larger than the representative value; and
codes the symbol including the non-unitary coefficient using a value that is obtained by subtracting the run value of the non-unitary coefficient from a limit value if the run value is found to be smaller than or equal to the representative value.

26. The encoder of claim 25, wherein the limit value is a value that is calculated from a value greater than a highest run value of the run values.

27. The encoder of claim 20, wherein the coefficient encoding unit codes information about the reference value.

28. The encoder of claim 20, wherein the coefficient encoding unit inserts and codes the representative value into a video signal of a slice or frame including the block.

29. The encoder of claim 20, wherein the coefficient encoding unit sets information providing notification of assignment of the codewords through comparison with the representative value, and wherein the representative value has been previously set.

30. A decoder for losslessly coding coefficients included in a block of a fine granularity scalability (FGS) layer constituting a coded video signal of a multi-layer structure, the decoder comprising:
a representative value extraction unit which extracts a representative value added to the coded video signal; and
a coefficient decoding unit which extracts codewords from the coded video signal, and, for the representative value and codewords belonging to first and second groups that are spaced apart from each other at a distance, transforms and decodes the codeword belonging to the first group and the codeword belonging to the second group using different methods.

31. The decoder of claim 30, wherein the representative value extraction unit extracts a value that is encoded in the video signal.

32. The decoder of claim 30, wherein the coefficient decoding unit compares a reference value and the representative value.

33. The decoder of claim 30, wherein the reference value is a value that is calculated form a highest run value of the run values.

34. The decoder of claim 30, wherein:
the codewords belonging to the first group is smaller than the codewords belonging to the second group;
the different methods comprise different first and second methods;
the first method is a method of setting a value that is obtained by adding the representative value to a decoded value of the codeword belonging to the first group, for a run value of the coefficients; and
the second method is a method of setting a value that is obtained by subtracting a decoded value of the codeword belonging to the second group from a limit value, for the run value of the coefficients.

35. The decoder of claim 34, wherein the limit value is a value that is calculated from a value greater than a highest run value of the run values.

36. The decoder of claim 30, further comprising a block creation unit which generates a block using the decoded coefficients.

37. The decoder of claim 30, wherein the representative value extraction unit decodes the representative value that is inserted along with a video signal of a slice or frame including the block.

38. The decoder of claim 30, wherein the representative value extraction unit extracts information providing notification of assignment of the codeword through comparison with the representative value, and wherein the representative value has been previously set.
